(19) United States
(12) Patent Application Publication
(10) Pub. No.: US 2016/0029615 A1
(43) Pub. Date: Feb. 4, 2016

(54) Airborne Bird Strike Countermeasure

(71) Applicant: Government of the United States, as represented by the Secretary of the Air Force, Wright-Patterson AFB, OH (US)

(72) Inventors: Jeffrey M. Newcamp, Monument, CO (US); Garrett D. Womack, Redlands, CA (US); Michael D. Foley, Monument, CO (US); Carson B. Fugal, Park City, UT (US)

(21) Appl. No.: 14/885,623

(22) Filed: Oct. 16, 2015

Related U.S. Application Data
(63) Continuation-in-part of application No. 14/622,186, filed on Feb. 13, 2015.
(60) Provisional application No. 61/939,377, filed on Feb. 13, 2014.

(51) Int. Cl. A01M 29/10; B64D 45/00; A01M 29/16

(52) U.S. Cl. CPC A01M 29/10; A01M 29/16; B64D 45/00; B64D 2045/0095

(57) ABSTRACT

A system for deterring bird strikes on an airborne aircraft is provided. The system includes at least one light configured to project light at optical wavelengths within an avian species optical sensitivity but having low or no observability by pilots. The light is further configured to flash. The system additionally includes at least one audio projection device configured to broadcast alert or predatory calls within avian species auditory capability. The audio projection device is also capable of audio projection in airflow having speeds up to about 250 KIAS.

### CROSS-REFERENCE TO RELATED APPLICATIONS

This application is a continuation-in-part of U.S. application Ser. No. 14/662,186, entitled “Airborne Bird Strike Countermeasure,” filed on Feb. 13, 2015, which is a non-provisional of and claims the benefit of and priority to U.S. Provisional Application Ser. No. 61/939,377, entitled “Airborne Bird Strike Countermeasure,” filed on Feb. 13, 2014, the entireties of which are incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

1. Field of the Invention

The present invention generally relates to the field of noise generating systems and, more particularly, a noise generating system that diverts geese and other birds from an oncoming airplane.

2. Description of the Related Art

For years geese and other birds have been sucked into the inlet portion of jet engines of airplanes, which can result in jet engine failure. In one such example of an aerial bird strike, an Airbus A320 with 155 passengers took off from LaGuardia Airport in New York City. During its initial climb, the plane struck a flock of Canada geese, resulting in the failure of both engines. The pilot and co-pilot managed to glide the aircraft into the Hudson River and saved everyone onboard. Fortunately, this incident resulted in only minor injuries; however, other reported accidents have ended under more tragic circumstances. An E-3B Sentry with 24 crew members, for example, crashed shortly after takeoff at Elmendorf Air Force Base, Alaska when engines No. 1 and No. 2 failed simultaneously. At the conclusion of the investigation, it was determined that the engines ingested a flock of Canada geese during takeoff, resulting in the deaths of all 24 crew members. Although accidents like these seem rare, aerial bird strikes are a common occurrence. According to the United States Air Force's Bird/Wildlife Aircraft Strike Hazard (BASH) team, between the years of 1995 and 2011, a total of 69,417 wildlife strikes were recorded resulting in $438 million in damages. The BASH team also concluded that a majority of these strikes involved aircraft below 10,000 feet above mean sea level (AMSL) and below Mach 0.391. Moreover, the United States Air Force (USAF) recorded an average of 6,500 bird strikes per year resulting in 1.3 fatalities and a loss of 1.2 aircraft per year. It should also be noted that the population of geese as well as commercial flight volume have both increased, thereby increasing the chances of such incidents. As a result of the dangers associated with the engulfment of birds into jet engines, there have been varying systems developed that provide signaling means, which are used to scare off or deflect birds from an airplane. The bulk of these systems are installed at ground level at airports.

The traditional BASH programs employed by the USAF, for example, are all ground based paradigms that have had varying degrees of effectiveness. The Avian Hazard Advisory System (AHAS), the Bird Avoidance Model (BAM), effigies, propane cannons, canines, predator birds and environmental mitigation are fine measures for reducing bird populations near runways. Unfortunately, these ground based systems are only effective within thousands of feet of the airfield property laterally and only hundreds of feet vertically. These contemporary methods fail to adapt to the changing flight environment as the aircraft is transitioning from the ground to flight and from landing/takeoff configuration to cruise configuration at thousands of feet above ground level.

Accordingly, there is a need in the art for an improved system to deter or divert birds from oncoming aircraft.

### SUMMARY OF THE INVENTION

Embodiments of the invention utilize a combination of sound and light sources mounted on an aircraft to deter avian species from maintaining a collision flight path with an aircraft. The sound used may be changed to target specific species or may be designed for a wider avian affect. The sound may be a frequency-specific tone or a predatory avian species call specific to a region and avian dialect. The light effect may be provided from existing installed aircraft landing lights, but with the ability to flash the lights at a designated frequency. Embodiments of the invention are intended to be an always-on system below 10,000 ft above ground level (AGL) and below 250 knots indicated airspeed (KIAS).

Embodiments of the invention provide a system for deterring bird strikes incorporated in an aircraft. The system includes at least one light configured to project light at optical wavelengths within an avian species' optical sensitivity but having low or no observability by pilots. The system further includes at least one audio projection device configured to broadcast alert or predatory calls within avian species' auditory capability. The audio projection device is capable of audio projection in airflow having speeds up to about 250 KIAS.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a diagrammatic representation of an embodiment of the invention;

FIG. 2 is an illustration of a potential location for implementation of embodiments of the invention on an aircraft;

FIG. 3 is a front view of the illustration in FIG. 2;

FIG. 4 is a side view of a portion of the illustration in FIG. 2;

FIG. 4A shows a potential installation location of embodiments of the invention on an actual Airbus A320® aircraft;

FIG. 4B shows another potential installation location of embodiments of the invention on an actual Airbus A320® aircraft;

FIG. 5 is a perspective view of an embodiment of the invention utilized for ground testing on avian species;

FIG. 6 is a top view of the embodiment in FIG. 5;

FIG. 7 is a front view of the embodiment in FIGS. 5 and 6;

FIG. 8 is a side view of the embodiment in FIGS. 5, 6, and 7;

FIG. 9 is a graph of spectra intensity of an aircraft landing light;

FIG. 10 is a graph of luminance of a landing light versus distance;

FIGS. 11A and 11B are graphs of error related to the effect of stimulus on participants; and

FIG. 12 is a graph showing the effect of stimulus on participants;

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Risk to mission, equipment, and personnel associated with bird strikes can be as high as or higher than wartime threats due to the lack of onboard defensive systems. For example, Manpad threats are fairly well mitigated by Missile Defense System Flares and Large Aircraft Infrared Countermeasures. Generally, the only active countermeasure for bird strikes are ground terminal based, covering limited geography or airspace, and those systems are not 100% effective. Embodiments of the invention address this need by providing a system using both light and sound integrated onto an aircraft to prevent bird strikes in the flight regime below 10,000 ft AGL and below 250 KIAS. Most avian species fly below this design altitude and most aircraft do not fly above this design airspeed when lower than 10,000 ft AGL.

In order to reduce damages and make flying safer for travelers and the military, embodiments of the invention provide a warning system designed to be incorporated onto an aircraft to mitigate the risk of aerial bird strikes. The resulting Airborne Bird Strike Countermeasure (ABC) system utilizes light and sound to alert birds of the approaching aircraft. A promising countermeasure to reduce the incidence of bird strikes is the use of flashing lights. Even though not all birds are sensitive to violet light at 380 to 430 nm, a set of flashing lights tuned to geese's optical sensitivity in the violet range at 380 to 430 nm would generally not be observed by pilots or others, a key safety measure. Induced flashing motion across the wings to simulate looming, flash frequency and controlled wavelengths of the lights may be able to provide sufficient visual contrast to alert threat birds in most instances. To complement the flashing lights, embodiments of the invention also equip aircraft with speakers to repel birds with alarm or predator calls or sirens.

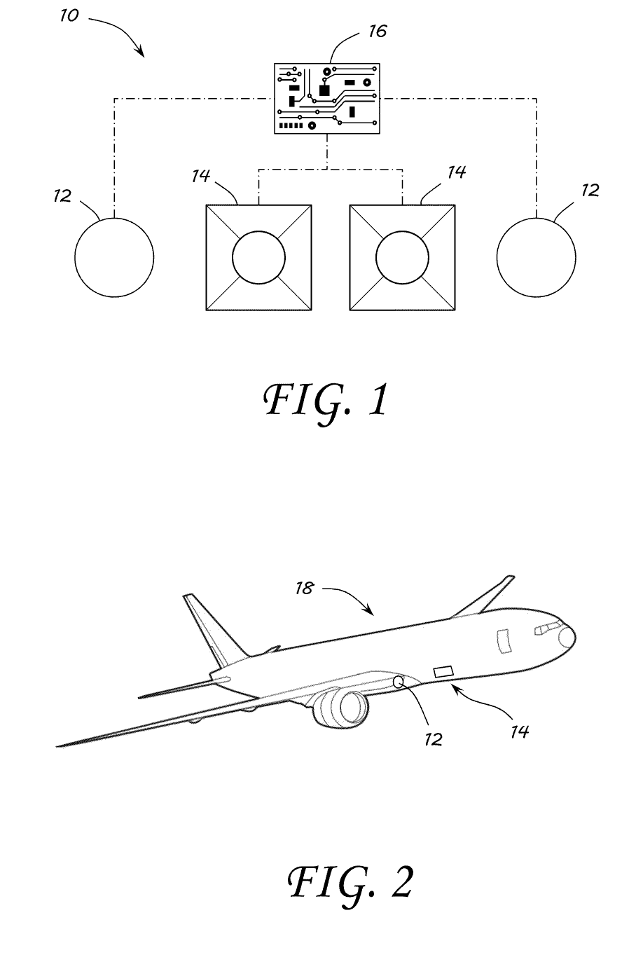

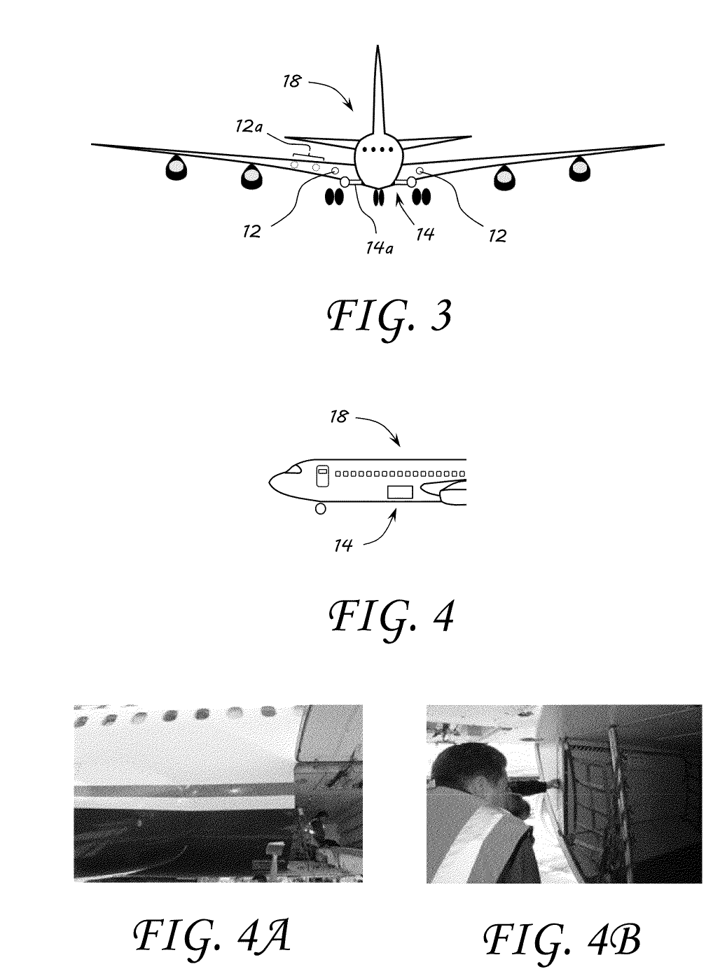

A diagrammatic representation of an exemplary embodiment 10 is illustrated in FIG. 1. Existing right and left aircraft landing lights 12 may be utilized and these existing lights may operate with adjustable flash rates or some embodiments. Other embodiments may utilize additional lights 12a (FIG. 3) along the leading edge of the wing or other forward location of the aircraft that would be visible to oncoming birds. A loudspeaker system 14 capable of delivering a decibel level in excess of flight noise would also be utilized. In some embodiments, the loudspeaker system 14 may include an adjustable sound input. Moreover, the loudspeaker system 14 may consist of a single speaker element to broadcast sounds, or in other embodiments, the loudspeaker may be made up of multiple speaker elements. The lighting and loudspeaker system are electrically coupled to internal circuitry 16 which may include flight ready hardware, circuit breaker panel, cockpit interface panel, and power sources.

The loudspeaker system 14 would generally be installed in the forward area of an aircraft 18 as illustrated in FIGS. 2-4. Other embodiments of the invention could potentially install the loudspeaker system toward the rear of the aircraft based on aircraft design and the amount of aircraft noise (engine and airframe) that the speakers will need to overcome. Using the A320® by Airbus as an example, the loudspeaker system 14 might be mounted in a forward cargo bay on an articulating arm 14a (FIG. 3), for example, so that the loudspeaker system 14 could be extended and retracted to reduce aerodynamic drag and thus increase fuel economy. FIG. 4A illustrates one such installation location. Right is forward in this photograph. The left and right sides of the A320® are similar, so the articulating arm could extend from a cargo area through a cutout in the aircraft skin. The arm, in some embodiments, would be forward-moving so that its failure mode would allow ram air to push the loudspeaker system 14 back into an aircraft cavity. FIG. 4B shows an internal view of a possible installation location on the A320®. The panel shown has a requisite internal volume (6 ft3) for the loudspeaker system 14 assembly. The articulating arms 14a on both sides of this location may require hydraulic power, which could be obtained through the aircraft hydraulic system. Other embodiments may employ other means to extend and retract the articulating arms 14a. In other embodiments, the loudspeaker system may be integral with the body of the aircraft. The loudspeaker system may be installed on the right and/or left forward body of aircraft 18 as set for the above or in other embodiments for rotary-wing aircraft, along a centerline. The lighting system is pre-existing, by utilizing the aircraft 18 landing lights, but requires the installation of the flashing circuitry. Aircraft mounting of embodiments of the invention would also require internal installation of a flashing unit to pulse the lights at about 0.75 Hz and wiring to the cockpit with a circuit breaker and a control box.

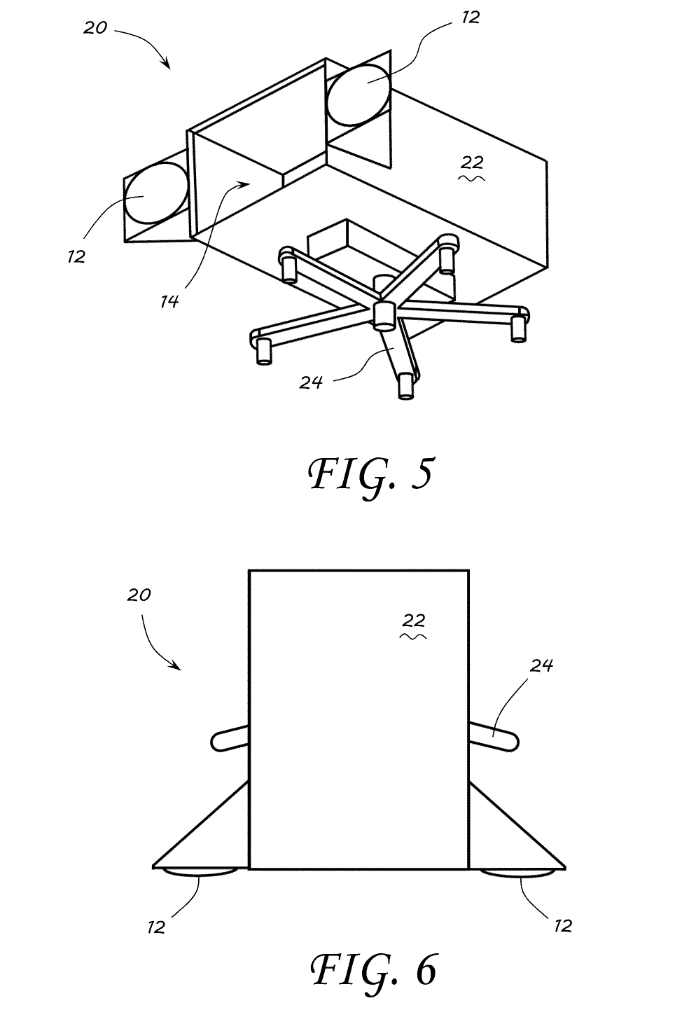

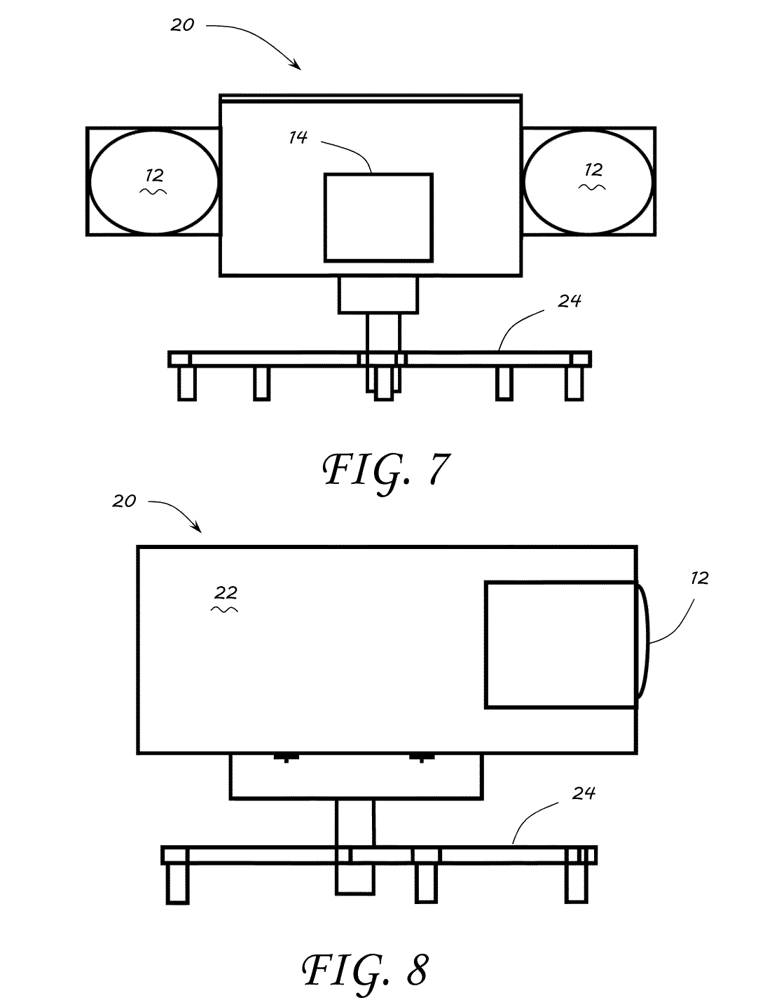

As a proof of concept, a test rig 20 illustrated in FIG. 5 was used for ground testing. The integration of the aircraft landing lights 12 and the loudspeaker system 14 are shown in FIGS. 5-8. These components are mounted in or to a housing 22 on a base 24. Test rig 20 employs two Airbus A320® landing lights 12 and a PowerSonix PSAIR12 speaker for the loudspeaker system 14. The test rig 20 uses a proprietary goose alarm call obtained through Bird-X, Inc. of Chicago, Ill., a vendor selling systems to airports and golf courses. The call is approximately six seconds in length and is played on loop overtop of noise of an Airbus A320's® CFM56 engine. A wind tunnel efficacy test was conducted on the PowerSonix PSAIR12 speaker. The loudspeaker system 14 was subjected to speeds up to 250 KIAS, while mounted on a sting (NACA 0012 airfoil sections used as stints). The speaker's structural integrity was sufficient at that speed, making it an ideal candidate for airborne mounting. As set forth above, in some embodiments, the loudspeaker system 14 will retract into the aircraft 18 prior to the cruise portion of flight, when higher speeds are encountered. Tones were played from 500 Hz to 4000 Hz and sound propagation was measured upstream of the speaker. The 1500 Hz tone performed the best, thus enabling trade space in that realm. Notably, a 1500 Hz tone is also within avian species hearing capability and projects well in airflow. Thus, the goose call and the tone are acceptable countermeasure sounds and may be utilized with embodiments of the invention.

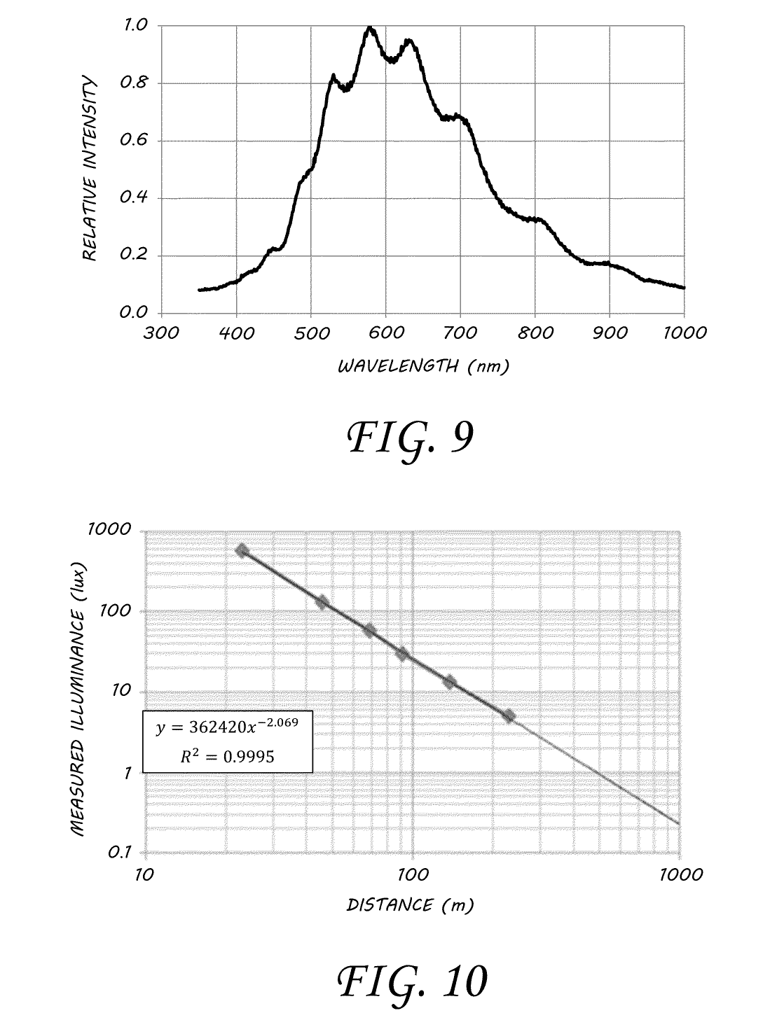

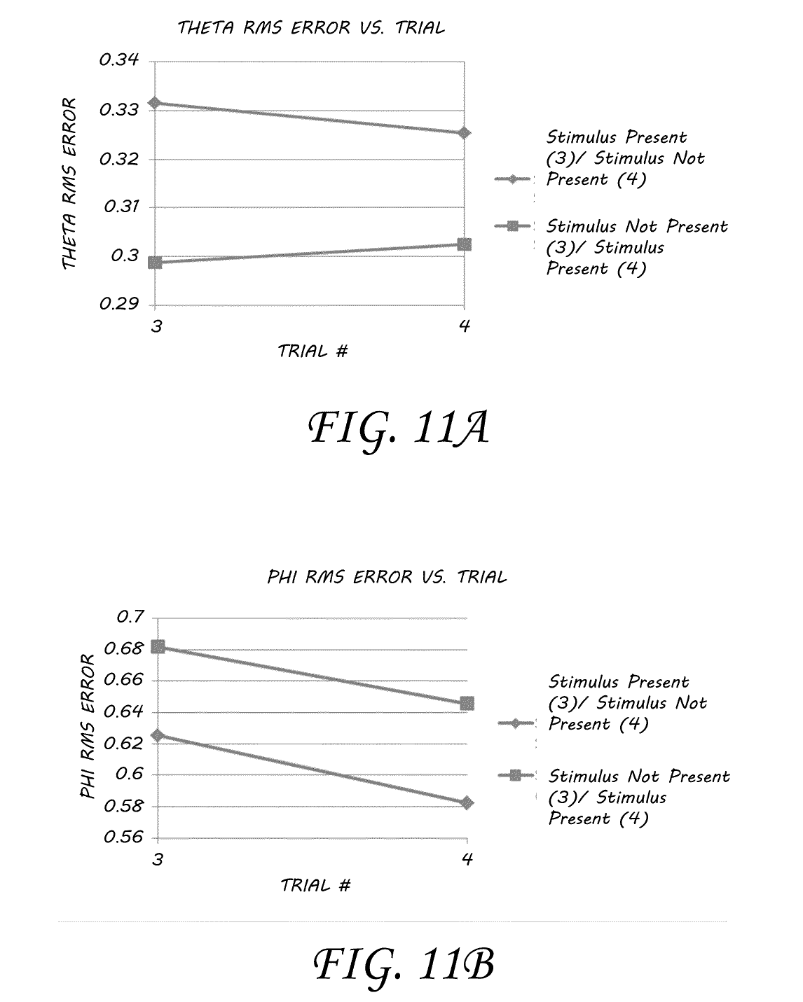

The test rig 20 uses two actual General Electric aircraft landing lights. This light is the same light used on Airbus A320® aircraft, part number GE Q4559X. It requires 600 Watts, 28 Volts AC and 21.5 Amps. Initial candle power is 765,000 Candela and the beam angle is 11° horizontal and 7.30° vertical. The relative spectral intensity of one of the A320 landing lights was measured with an Ocean Optics Red Tide USB650 Spectrometer. The optical resolution of the measurement system was ±2 nm and the signal to noise in the intensity was 250:1 at full signal. FIG. 9 shows the result. The illuminance of one landing light was also measured at full power. The light was positioned three feet above the ground and measured at a similar height with a handheld lux meter, model Dr Meter LX1330B, at varying distances. The meter will accept light reflected off the ground. FIG. 10 shows the data and curve fit. At 1 km, the data can be extrapolated to give an estimate of 0.23 lux for each landing light. The total from two lights would be 0.45 lux. At 1.1 km, the two would provide 0.37 lux. Given uncertainties in the sensor and atmospheric transmission, the uncertainty in these estimates is assumed to be ±50%.

A study was conducted and limited tests were performed of the possible use of visual and acoustic airborne countermeasures to reduce the frequency of bird strikes on aircraft. Flashing lights in the violet range at 400 to 430 nm and speakers broadcasting alarm, predator calls, or sirens at audio frequencies corresponding to avian audio sensitivities that are more noticeable to threat birds than the drone of aircraft noise were found to be effective. A set of flashing lights tuned to the geese's optical sensitivity at violet wavelengths would generally not be observed by pilots within both other aircraft and own aircraft, a key safety measure. Alternatively, existing aircraft landing lights that project in the visual spectrum could be effective deterrents as well. The perceived motion across the wings, flash frequency and wavelength of the lights may be able to provide sufficient visual contrast to alert most threat birds.

A Human factors experiment tested the potential effects of audio, visual, and heat stimuli and how these stimuli could affect pilots during high cognitive workload (critical) phases of flight. The experiment tested pilots flying a Calspan 4000 flight simulator while performing sinusoidal tracking tasks and secondary cognitive tasks during 90-second trials with external stimuli present. The external stimuli included a 90 dB goose distress call and a 600 Watt aircraft landing light flashing at 0.75 Hz positioned five feet in front of the pilot at a 45-degree angle that increased surface temperature by 11 degrees Fahrenheit over the 90-second test period. All participants had a minimum of 10 logged flight hours in varying aircraft and participated in two randomized trials with the external stimulus present and two control trials without the stimulus present. Each trial consisted of participants completing 90-seconds of sinusoidal tracking tasks while researchers asked math and logic questions to simulate increased cognitive workloads.

Of the 31 participants who participated in this experiment, the data from two participants were outliers and were excluded. These outliers were excluded because the participants met the preset desired performance parameters on average less than five seconds per trial for each of the four 90-second trials. Excluding these outliers, 29 participants performed adequately and their performance was subsequently analyzed.

Using the John's Macintosh Program (JMP) software developed by the JMP business unit of the SAS institute, multiple MANOVA statistical tests were used to analyze the collected data. A probability of 0.05 was used to determine significance. Trials were split into two test conditions, with one condition signifying that the first and third trials had the stimulus present and the second and forth trials did not have the stimulus present. The second condition signified that the first and third trials did not have the stimulus present while the second and fourth trials did have the stimulus present.

After performing each trial, participants were given a Theta Root Mean Square (RMS) Error and the Phi RMS Error which evaluated their sinusoidal tracking performance. The lower the error, the better the participant performed regarding the tracking tasks. A MANOVA test was conducted on the Theta RMS Error between the two conditions. It was found that the Prob>F for the trial number was 0.0003 and the Prob>F for the trial number versus the condition was 0.6194. This shows that there was an interaction between trial numbers, meaning that a learning effect occurred for participants as the experiment progressed through the trials. However, there was no interaction between the trial number and the condition, meaning that the presence of the stimulus did not have an effect on the ability of the participant to perform the tracking tasks throughout all trials. Running a MANOVA test on the Phi RMS Error yielded similar results, with a Prob>F for the trial number equal to 0.0075 and a Prob>F for the trial number versus the condition equal to 0.7941.

However, although a learning effect occurred across all trials analyzed together, when the Theta RMS Error and Phi RMS Error across Trial 3 and Trial 4 were analyzed, there was no learning effect present. The Prob>F for the trial number analyzed across Trial 3 and Trial 4 was 0.906 for the Theta RMS Error and 0.0515 for the Phi RMS Error. This indicates that no significant interaction existed between the second set of trials and no significant learning effect was present during the final two trials of the experiment. A Prob>F for the Trial number versus the condition was 0.6272 for the Theta RMS Error and 0.8621 for the Phi RMS Error, indicating that although no learning effect was present, the presence of the stimuli still did not affect pilot performance regarding the sinusoidal tracking task across the last set of trials. FIGS. 11A and 11B show the graphical analysis of these results.

With no learning effect present for the final two 90-second trials, the presence of the external stimuli did not significantly affect participants' performance regarding the sinusoidal tracking task. The trend of the Theta and Phi RMS Error across Trial 3 and Trial 4 were very close regardless of the condition to which participants were subjected.

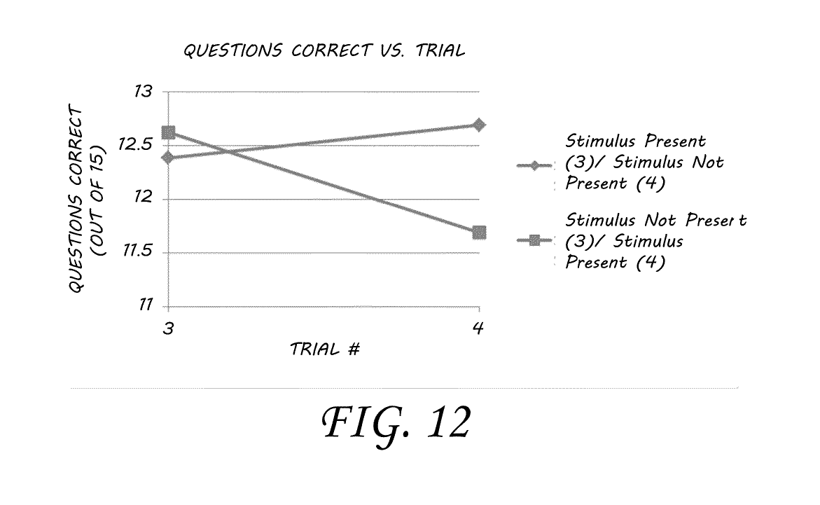

Because it was determined that a learning effect was no longer present between Trial 3 and Trial 4, these two trials were analyzed regarding the secondary cognitive task. Running a MANOVA test that assessed the number of questions answered correctly out of 15 between Trial 3 and Trial 4, it was found that the Prob>F for the Trial number equaled 0.2744 (confirming that no learning effect was present) and the Prob>F for the Trial number versus the condition equaled 0.0361. This result showed that an interaction did occur between conditions and that participants performed worse on the secondary cognitive task with the external stimuli present. FIG. 12 shows the graphical analysis of this result.

With the stimulus present, participants answered an average of 12 questions correct while participants answered an average of 12.7 questions correct without the stimulus present.

After analyzing the results, it became apparent that even with measures in place to eliminate a learning effect, a learning effect did occur during the first two trials; however, the last two trials did not experience a learning effect. Assessing Trial 3 and Trial 4, running a MANOVA test with the statistical significance set to 0.05 for the Theta and Phi RMS Error showed that the presence of the external stimuli did not affect participant performance regarding the sinusoidal tracking task. However, a MANOVA test on the questions correct between Trial 3 and 4 showed that the external stimuli did negatively affect the secondary cognitive task performance.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A system for deterring bird strikes incorporated in an aircraft, the system comprising:
at least one light configured to project light at optical wavelengths within an avian species optical sensitivity but having low or no observability by pilots; and
at least one audio projection device configured to broadcast alert or predatory calls within avian species auditory capability,
wherein the audio projection device is capable of audio projection in airflow having speeds up to about 250 KIAS.

2. The system of claim 1, wherein the at least one light is further configured to flash.

3. The system of claim 2, wherein the at least one light is configured to flash at 0.75 Hz.

4. The system of claim 1, wherein the at least one light is configured to project light in a violet range at 380 to 430 nm.

5. The system of claim 1, wherein the at least one light is a first light, the system further comprising:
a second light configured to project light at optical wavelengths within an avian species optical sensitivity but having low or no observability by pilots and being further configured to flash,
wherein the first light and second light are positioned on opposite sides of a fuselage of the aircraft.

6. The system of claim 1, wherein the audio projection device is configured to broadcast at frequencies between about 500 Hz to about 4000 Hz.

7. The system of claim 6, wherein the audio projection device is configured to broadcast at a frequency of about 1500 Hz.

8. The system of claim 1, wherein the audio projection device is mounted inside a forward baggage compartment.

9. The system of claim 1, wherein the audio projection device is mounted on an articulating arm attached to a fuselage of the aircraft, the articulating arm configured to move from a first position integral with the aircraft to a second deployed position directing an output of the audio projection device in a direction forward of the aircraft.
